(19) United States
(12) Patent Application Publication
(10) Pub. No.: US 2006/0214387 A1
(43) Pub. Date: Sep. 28, 2006

(54) Hand powered bicycle

(76) Inventor: Theodore H. Walthall, King George, VA (US)

Correspondence Address: Christopher J. McDonald;HOFFMAN, WASSON & GITLER, P.C., Suite 522, 2461 South Clark Street, Arlington, VA, 22202, US

(21) Appl. No.: 11/387,906

(22) Filed: Mar. 24, 2006

Related U.S. Application Data
(60) Provisional application No. 60/664,703, filed on Mar. 24, 2005.

(51) Int. Cl. B62M 1/14

(52) U.S. Cl. 280/246; 280/258

(57) ABSTRACT

A frame supports two rear wheels, a front wheel and a seat. Extending upwardly from the steering column mounting bracket in the front of the frame is a rocking drive steering column pivotally connected to the steering column mounting bracket. Pivoting the rocking drive steering column back and forth drives a center rocking bar to provide rotation to an orbital ratchet through the orbital ratchet drive rod. The orbital ratchet drives a chain which extends through a drive train to power the rear wheels. The handlebars are connected to a gooseneck extending through the rocking drive steering column. The gooseneck rotates within the rocking drive steering column when the handlebars are turned and provide rotational motion to the front wheel fork shaft through a universal joint to steer the front wheel.

This application claims the benefit of Provisional Application Ser. No. 60/664,703, filed Mar. 24, 2005.

### BACKGROUND OF THE INVENTION

Bicycles are often powered by pedals turning a sprocket driving a chain attached to a second sprocket to drive a wheel. Bicycles are in the potential upright or recumbent styles. For those people who do not have full use of the legs, bicycles having pedals turned by the user's hands have been developed. However, the use of the hands to turn the pedals makes steering the bicycle difficult.

It is an object of the invention to provide a bicycle having the ability to be powered and steered at the same time.

It is another object of the invention to provide a bicycle having a rocking drive steering column extending between the handle bars and frame pivoting to provide power to the rear wheels.

It is another object of the invention to provide a linkage between the handlebars and front wheels allowing steering through a variety of angles.

It is yet another object of the invention to provide a bicycle having a rocking drive mechanism that transfers power to a chain through both the forward and backward strokes.

These and other objects of the invention will be apparent to one of ordinary skill in the art after reading the disclosure of the invention.

### SUMMARY OF THE INVENTION

A frame supports two rear wheels, a front wheel and a seat. Extending upwardly from the steering column mounting bracket in the front of the frame is a rocking drive steering column pivotally connected to the steering column mounting bracket. Pivoting the rocking drive steering column back and forth drives a center rocking bar to provide rotation to an orbital ratchet through the orbital ratchet drive rod. The orbital ratchet drives a chain which extends through a drive train to power the rear wheels. The handlebars are connected to a gooseneck extending through the rocking drive steering column. The gooseneck rotates within the rocking drive steering column when the handlebars are turned and provide rotational motion to the front wheel fork shaft through a universal joint to steer the front wheel.

### BRIEF DESCRIPTION OF THE DRAWINGS

FIG. 1 is a perspective view of the bicycle with all parts labeled;

FIG. 2 is an exploded view of the steering column and front fork assembly;

FIG. 3 is an exploded view of the drive assembly;

FIG. 4 is an exploded view of the chain guard and orbital ratchet;

FIG. 5 is a schematic view of the chain assembly; and

FIG. 6 is a side view of a second embodiment of the bicycle.

### DETAILED DESCRIPTION OF THE INVENTION

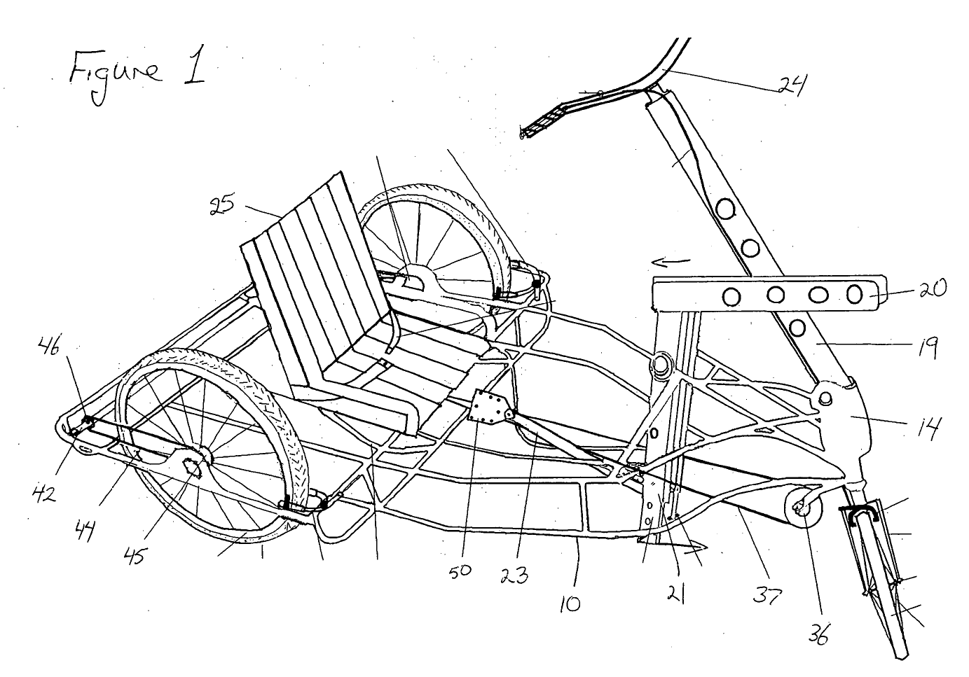

FIG. 1 shows a bicycle having a frame 10 supporting a seat 25, the front wheel and a pair of rear wheels. Handle bars 24 extend from the top of a rocking drive steering column 19, which is pivotally connected to the steering column mounting bracket 14 at the front of the frame. Pivotally connected to the rocking drive steering column 19 is a center rocking bar drive rod 20 formed a pair of rods connected to either side of the rocking drive steering column. Extending downwardly from the center rocking bar drive rod 20 and pivotally connected to the frame is the center rocking bar 21. This center rocking bar 21 is connected to the orbital ratchet drive rod 23, which terminates in the orbital ratchet 50, which will be described later.

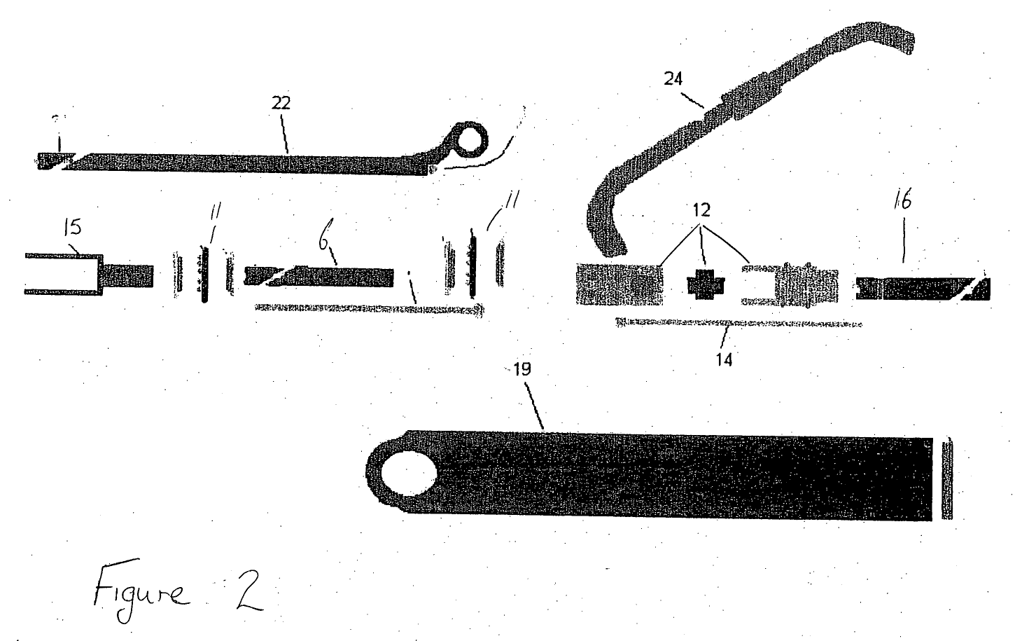

FIG. 2 shows an exploded view of the parts comprising the steering column and the rocking drive. The handle bars 24 are attached to gooseneck 22. The gooseneck connects to the upper universal rod 16 and universal joint 12. The gooseneck could connect to the universal, if desired. Attached to either side of the gooseneck 22 is the rocking drive steering column 19. Extending below and attached to the universal joint 12 is the fork shaft 6 connected to the forks 15 for retaining the front wheel. The universal joint is located at the pivot point of the rocking drive steering column 19 and frame 10. This allows the angle between the gooseneck 22 and fork shaft 6 to be changed as the gooseneck moves with the rocking drive steering column 19, yet is still able to cause rotation of the fork shaft and allow steering of the front wheel. The assembly also includes conventional bearings 11.

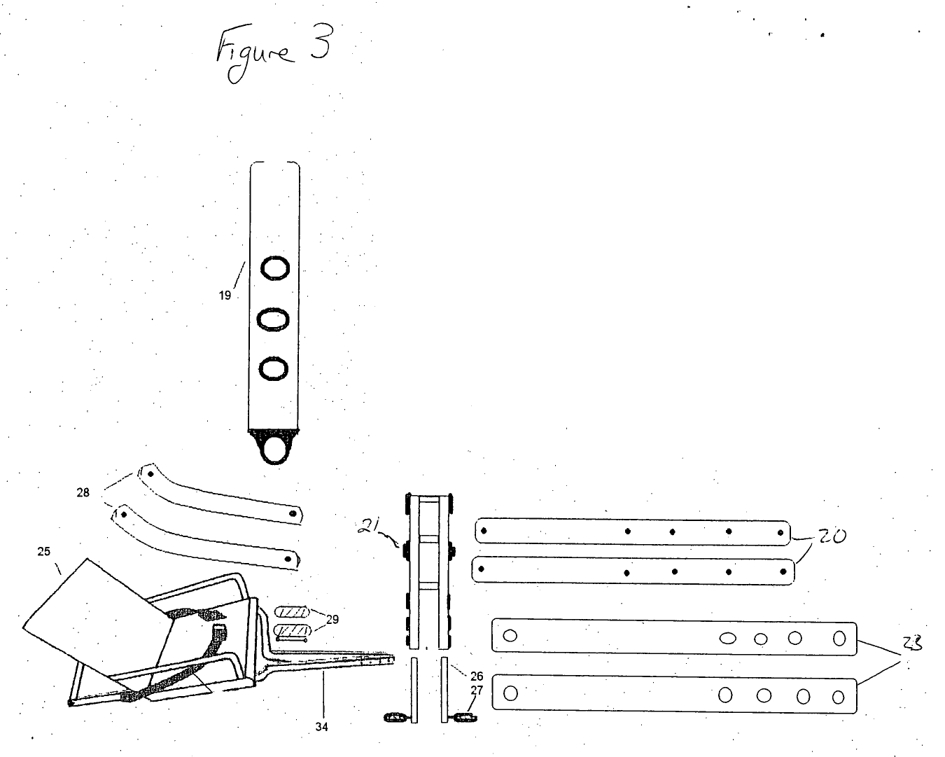

FIG. 3 shows the rest of the drive mechanism, including the rocking drive steering column 19 and the center rocking bar 21. As can be seen, both the rocking drive steering column 19 and center rocking bar 21 are provided with multiple apertures allowing the connection between these two elements and the center rocking bar drive rod 20 to be adjusted. Extending from the center rocking bar 21 are adjustable pedal rods 26 and pedals 27. Extending between the center rocking bar 21 and rocking drive steering column 19 are the center rocking bar drive rods 20. Extending from the center rocking bar 21 is orbital ratchet drive bars 23. Extending from the seat 25 is the lifting seat drive bar 34 causing upward movement of the seat when the rocking drive steering column 19 is pulled downwardly towards the seat. The seat is also supported by pivoted bars 28. The assembly also includes foot rests 29 that are attached to the frame at a suitable location.

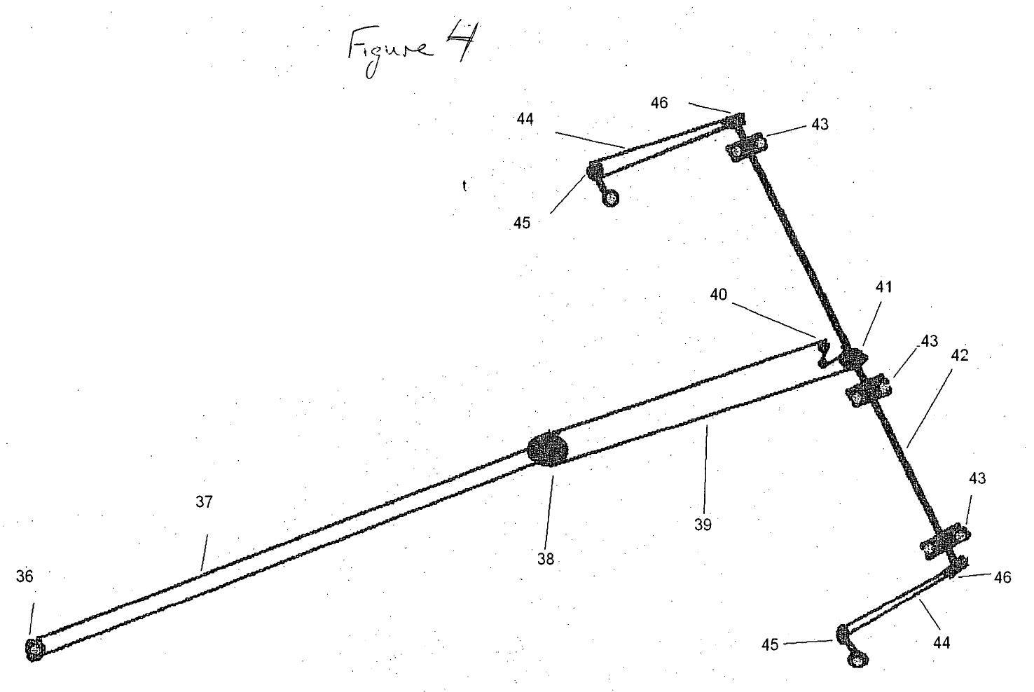

The chain and gear assembly used to translate movement of the orbital ratchet 50 into movement of the rear wheels is clearly seen in FIG. 4. A center pulley 38 has a front chain 37 extending forwardly to the front chain pulley 36 and a rear chain 39 extending backwardly through a gear changer 40 and a rear pulley 41 attached to a rear axle 42. Movement of the rear chain 39 causes rotation of the rear axle 42. The rear axle is attached to the frame by axle brackets 43. Rotation of the axle causes movement of the rear wheel chains 44 extending between sprockets 45,46 attached to the rear wheels and rear axle, respectively. A single chain could be used between the rear axle and the front chain pulley.

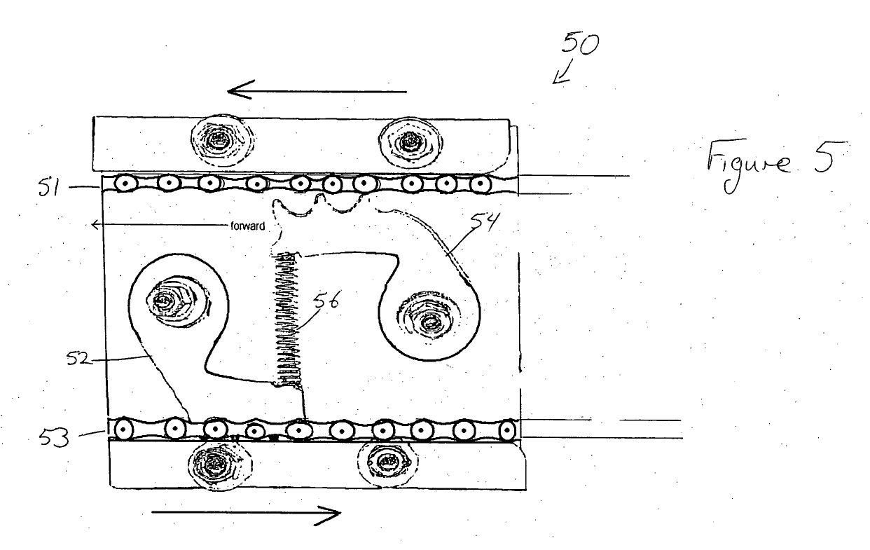

FIG. 5 shows the inside of the orbital ratchet 50, which allows the upper side 51 of the chain to be moved in one direction upon movement of the rocking drive steering column in one direction and allows the lower side 53 to be moved in the opposite direction when the rocking drive steering column is moved in the opposite direction. The result is a continuous circular motion of the chain throughout the entire range of motion of the rocking drive steering column.

The orbital ratchet 50 moves back and forth with the orbital ratchet drive rods 23. One of the ratchet arms 52 engages the chain and moves the chain along with the orbital ratchet. When the orbital ratchet changes direction, the ratchet arm 52 releases and the other ratchet arm 54 engages the other side of the chain. During forward movement of the orbital ratchet, the ratchet arm 54 engages the upper side 51 of the chain and, with backwards movement of the orbital ratchet, the ratchet arm 52 engages the lower side 53 of the chain. The change in engagement is aided by spring 56 extending between the ratchet arms.

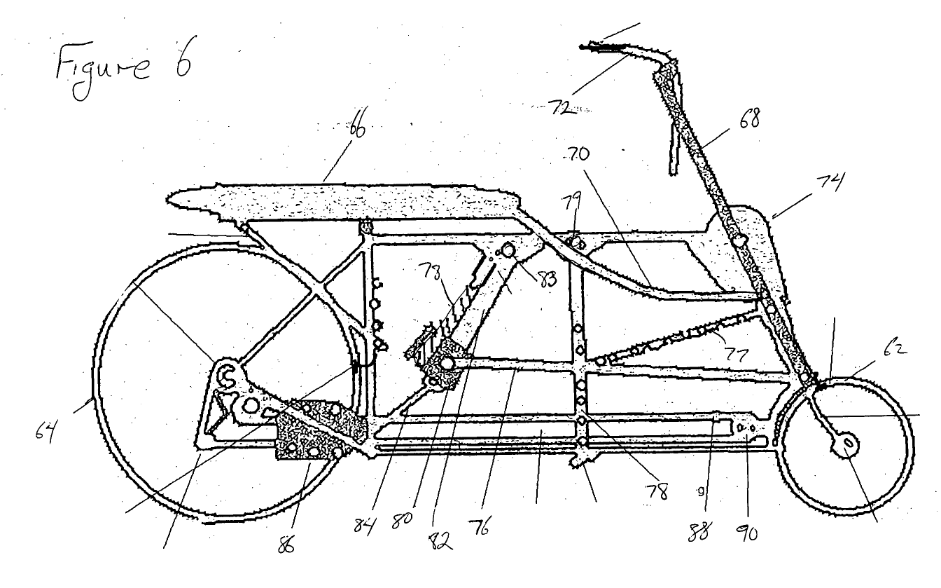

FIG. 6 depicts an alternative embodiment of the bicycle. The frame supports a front tire 62, rear tire 64 and seat 66. Lifting seat drive bars 70 extend from the seat and are pivotally connected to a rocking drive steering column 68. Handlebars 72 extend down within the rocking drive steering column to the front forks in order to steer the front wheel. The connection uses a universal joint to allow turning of the front fork by the handlebars despite the rocking motion of the rocking drive steering column 68, as was explained with reference to FIG. 2.

The rocking drive steering column 68 is pivotally connected to the frame's steering column mounting bracket 74. Pivotally connected to the rocking drive steering column below the mounting bracket is a center rocking bar drive rod 76 and a linkage 77 pivotally connected to a pedal swing bar 78. The pedal swing bar 78 is pivotally connected at joint 79 to the frame and formed by two parallel bars. The center rocking bar drive rod extends between the two parallel bars.

Extending downwardly from the frame is a threaded rod 81 supporting a gear block 80. The gear block can move upwardly and downwardly along the threaded rod. A center rocking bar 82 is pivotally connected to the frame at joint 83. Extending from and pivotally connected to the gear block is the center rocking bar drive rod 76, driven by the rocking drive steering column 68. Extending downwardly from the center rocking bar is an orbital ratchet drive rod 84, which leads to a horizontal to orbital ratchet 86. The horizontal-to-orbital ratchet, similar to the orbital ratchet 50, translates the oscillating motion of the end of the orbital ratchet drive rod 84 into rotational movement of the chain 88 extending from the ratchet to the front chain pulley 90.

As the rocking drive steering column is pulled backward and forward 68, the center rocking bar 82, driven by the center rocking bar drive rod 76, and pedal swing bar 78, driven by linkage 77, pivot about their connection to the frame. The placement of the gear block along the center rocking bar affects the amount of movement of the center rocking bar drive rod as the further up along the center rocking bar it is placed, the more movement results in the orbital ratchet driving rod.

While the invention has been described with reference to the preferred embodiment, variations and modifications would be apparent to one of ordinary skill in the art. Such modifications and variations are within the scope of the invention.

I claim:

1. A bicycle, comprising
a frame,
at least one rear wheel attached to the frame;
a front wheel,
a steering column, pivotally connected to the frame,
a linkage extending from said steering column to orbital ratchet,
a chain extending between a front sprocket and a rear sprocket to drive said at least one wheel, the chain having an upper side and a lower side, said chain extending through said orbital ratchet,
said orbital ratchet having a first ratchet arm engaging the chain upper side on forward movement of the steering column and a second ratchet arm engaging the chain lower side on backward movement of the steering column.

2. The bicycle of claim 1, wherein
said linkage comprises a center rocking bar drive rod pivotally connected to said steering column,
a center rocking bar pivotally connected to the center rocking bar drive rod, and
orbital ratchet drive bar extending between the center rocking bar and the orbital ratchet.
